(19) United States
(12) Patent Application Publication
(10) Pub. No.: US 2016/0099631 A1
(43) Pub. Date: Apr. 7, 2016

(54) SPINDLE MOTOR AND HARD DISK DRIVE INCLUDING THE SAME

(71) Applicant: Samsung Electro-Mechanics Co., Ltd., Suwon-Si (KR)

(72) Inventor: Dong Jin KIM, Suwon-Si (KR)

(73) Assignee: SAMSUNG ELECTRO-MECHANICS CO., LTD., Suwon-Si (KR)

(21) Appl. No.: 14/636,903

(22) Filed: Mar. 3, 2015

(30) Foreign Application Priority Data
Oct. 1, 2014 (KR) 10-2014-0132278

(51) Int. Cl. H02K 7/08; G11B 21/10

(52) U.S. Cl. CPC H02K 7/085; G11B 21/106

(57) ABSTRACT

A spindle motor includes a stator including a sleeve, and a rotor forming a bearing clearance with the sleeve, the bearing clearance being filled with a lubricating fluid. The rotor includes a stopper member forming a sealing part with the sleeve, in which a liquid-vapor interface is formed, and at least one of the stopper member and a surface of the sleeve disposed to face the stopper member is provided with an impact alleviating part formed therein to alleviate external impacts.

### CROSS-REFERENCE TO RELATED APPLICATION

This application claims the priority and benefit of Korean Patent Application No. 10-2014-0132278 filed on Oct. 1, 2014, with the Korean Intellectual Property Office, the disclosure of which is incorporated herein by reference.

### BACKGROUND

The present disclosure relates to a spindle motor and a hard disk drive including the same.

Generally, a small-sized spindle motor used in a hard disk drive (HDD) includes a rotor and a stator.

In such a small-sized spindle motor, a bearing clearance filled with a lubricating fluid is commonly formed in the spindle motor by the rotor and the stator. In addition, fluid dynamic pressure may be formed in the lubricating fluid filling the bearing clearance when the lubricating fluid is compressed at the time of rotation of the rotor, thereby rotatably supporting the rotor.

However, in accordance with the thinning of spindle motors, it may be difficult to satisfy impact resistance characteristics, among levels of performance required in the spindle motor.

Therefore, the development of a structure capable of improving the impact resistance characteristics is required.

### RELATED ART DOCUMENT

(Patent Document 1) Korean Patent Laid-Open Publication No. 2013-0073688

### SUMMARY

An aspect of the present disclosure may provide a spindle motor having improved impact characteristics, and a hard disk drive including the same.

According to an aspect of the present disclosure, a spindle motor may include a stator including a sleeve, and a rotor forming a bearing clearance with the sleeve, the bearing clearance being filled with a lubricating fluid, wherein the rotor includes a stopper member forming a sealing part with the sleeve, in which a liquid-vapor interface is formed, and at least one of the stopper member and a surface of the sleeve disposed to face the stopper member is provided with an impact alleviating part formed therein to alleviate external impacts.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view showing a spindle motor according to an exemplary embodiment of the present disclosure;

FIG. 2 is an enlarged view of part A of FIG. 1;

FIG. 3 is a perspective view showing a stopper member included in the spindle motor according to an exemplary embodiment of the present disclosure;

FIG. 4 is a schematic cross-sectional view showing a spindle motor according to another exemplary embodiment of the present disclosure;

FIG. 5 is an enlarged view showing part B of FIG. 4;

FIG. 6 is a view for describing an operation of the spindle motor according to another exemplary embodiment of the present disclosure; and

FIG. 7 is a schematic cross-sectional view showing a hard disk drive according to an exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

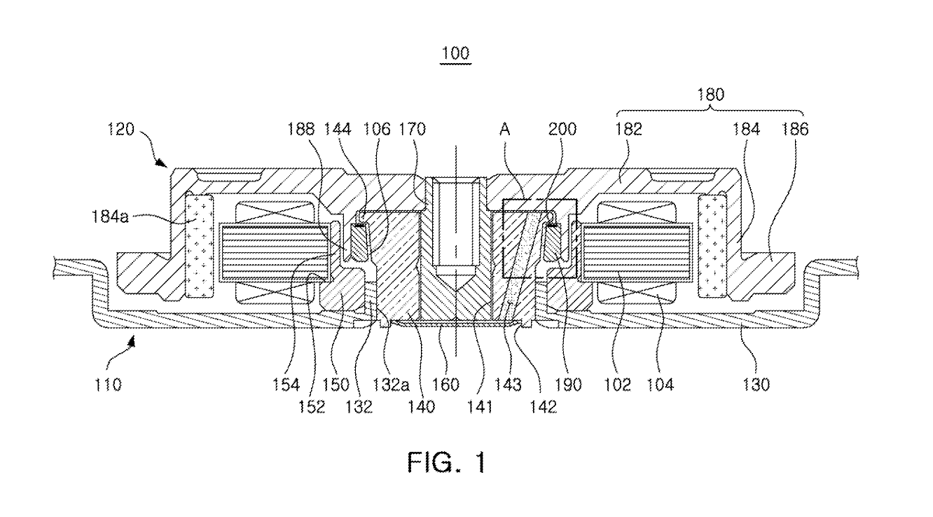

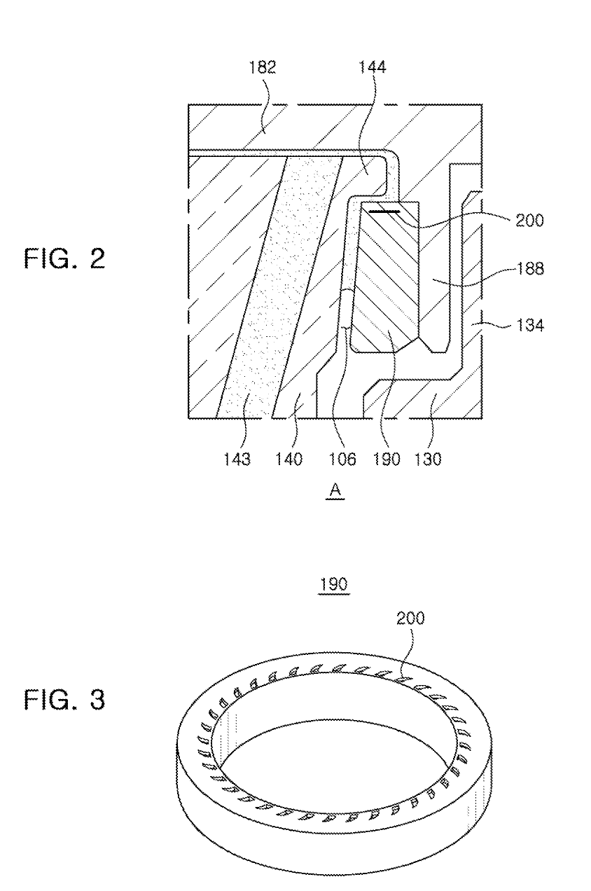

FIG. 1 is a schematic cross-sectional view showing a spindle motor according to an exemplary embodiment of the present disclosure; FIG. 2 is an enlarged view of part A of FIG. 1; and FIG. 3 is a perspective view showing a stopper member included in the spindle motor according to an exemplary embodiment of the present disclosure.

Referring to FIGS. 1 through 3, a spindle motor 100 according to an exemplary embodiment of the present disclosure may include a stator 110 and a rotor 120 by way of example.

The stator 110 may include a base member 130, a sleeve 140, an installation member 150, and a cover member 160. In addition, the rotor 120 may include a shaft 170, a rotor hub 180, and a stopper member 190.

Here, terms with respect to directions will be defined. As viewed in FIG. 1, an axial direction refers to a vertical direction, that is, a direction from a lower end portion of the shaft 170 toward an upper end portion thereof or a direction from the upper end portion of the shaft 170 toward the lower end portion thereof, and a radial direction refers to a horizontal direction, that is, a direction from an outer peripheral surface of the rotor hub 180 toward the shaft 170 or a direction from the shaft 170 toward the outer peripheral surface of the rotor hub 180.

In addition, a circumferential direction refers to a rotation direction along an outer peripheral surface of the shaft 170 or the rotor hub 180.

The stator 110 will be first described. The base member 130 may include a mounting part 132 protruding in an upward axial direction and having a lower end portion of the sleeve 140 inserted thereinto. That is, the mounting part 132 may have a mounting hole 132a formed therein so that the lower end portion of the sleeve 140 may be inserted thereinto.

Meanwhile, the base member 130 may be formed by press working by way of example. That is, the base member 110 may be formed by performing plastic deformation on a steel sheet. However, the present disclosure is not limited thereto. That is, the base member 130 may be formed of various materials and be manufactured by various processing methods. For example, the base member 130 may be formed of performing die-casting on aluminum.

The sleeve 140 may be fixed to the mounting part 132 of the base member 130. That is, the sleeve 140 may be installed in the base member 130 so that the lower end portion of the sleeve 140 is inserted into the mounting part 132. Meanwhile, the sleeve 140 may be installed in the mounting part 132 by at least one of a press-fitting method, a welding method, and an adhesion method.

In addition, the sleeve 140 may include a shaft hole 141 formed therein so that the lower end portion of the shaft 170 of the rotor 120 may be inserted thereinto. That is, the lower end portion of the shaft 170 may be inserted into the shaft hole 141 described above. In addition, an inner peripheral surface of the sleeve 140 and an outer peripheral surface of the shaft 170 may be disposed to be spaced apart from each other by a predetermined interval, thereby forming a bearing clearance in which a lubricating fluid is filled.

Meanwhile, the sleeve 140 may include an installation groove 142 formed in a lower end portion thereof to allow the cover member 160 to be installed therein. In addition, the sleeve 140 may have a circulation hole 143 formed therein in order to circulate the lubricating fluid, wherein the circulation hole 143 may be inclined. That is, the circulation hole 143 may be inclined so that the lubricating fluid may be more smoothly circulated by centrifugal force.

In addition, the circulation hole 143 may serve to decrease generation of negative pressure within the bearing clearance and serve to smoothly discharge air bubbles to the outside.

Further, the sleeve 140 may have a catching jaw 144 formed at an upper end portion of an outer peripheral surface thereof, wherein the catching jaw 144 protrudes to be disposed to face an upper surface of the stopper member 190.

In addition, the sleeve 140 may have upper and lower radial dynamic grooves (not shown) formed in an inner surface thereof in order to generate fluid dynamic pressure by pumping the lubricating fluid filled in the above-mentioned bearing clearance. As described above, the rotor 120 may more stably rotate by the fluid dynamic pressure generated by the upper and lower radial dynamic grooves.

The installation member 150 may be fixedly installed on the base member 130. That is, the installation member 150 may be seated on an upper surface of the base member 130, and have an inner peripheral surface bonded to an outer peripheral surface of the mounting part 132.

Meanwhile, the installation member 150 may include a seating surface 152 supporting a lower surface of a stator core 102 and a protrusion wall body 154 to which an inner peripheral surface of the stator core 102 is bonded. In addition, an inner peripheral surface of the protrusion wall body 154 may form a labyrinth seal with the rotor 120.

In addition, the stator core 102 may be installed on the installation member 150 by at least one of a press-fitting method and an adhesion method. Further, the installation member 150 may also be installed on the base member 130 by at least one of a press-fitting method, an adhesion method, and a welding method.

The cover member 160 may be bonded to the installation groove 142 of the sleeve 140. In addition, the cover member 160 may have a disk shape and serve to prevent the lubricating fluid from being leaked from the bearing clearance.

Meanwhile, the cover member 160 may also be bonded to the installation groove 142 by at least one of an adhesion method and a welding method.

Next, the rotor 120 will be described.

The shaft 170 of the rotor 120 may be inserted into the shaft hole 141 of the sleeve 140 and be supported by the fluid dynamic pressure generated at the time of being rotated. In addition, the upper end portion of the shaft 170 may protrude upwardly of the sleeve 140 to allow the rotor hub 180 to be installed thereon.

In addition, the rotor hub 180 may be fixed to the upper end portion of the shaft 170 and rotate with the shaft 170. The rotor hub 180 may include a body 182 having a disk shape, a magnet mounting part 184 extended from an edge of the body 182 in a downward axial direction, and a disk support part 186 extended from the magnet mounting part 184 in the radial direction.

In addition, the magnet mounting part 184 may include a driving magnet 184a fixedly installed on an inner surface thereof. Therefore, an inner surface of the driving magnet 184a may be disposed to face a front end of the stator core 102.

Meanwhile, the driving magnet 184a may be a permanent magnet generating magnetic force having a predetermined strength by alternately magnetizing an N pole and an S pole thereof in the circumferential direction.

Here, a rotational driving scheme of the rotor 120 will be briefly described. When power is supplied to a coil 104 wound around the stator core 102, driving force capable of rotating the rotor hub 180 may be generated by an electromagnetic interaction between the stator core 102 around which the coil 104 is wound and the driving magnet 184a to rotate the rotor hub 180.

That is, the driving magnet 184a and the stator core 102 disposed to face the driving magnet 184a and having the coil 104 wound therearound may electromagnetically interact with each other to rotate the rotor hub 180.

In addition, the shaft 170 on which the rotor hub 180 is installed and the stopper member 190 installed on an extension wall portion 188 of the rotor hub 180 may rotate with the rotor hub 180 by the rotation of the rotor hub 180.

Meanwhile, the extension wall portion 188 on which the stopper member 190 is to be installed may be provided on a lower surface of the rotor hub 180, in order words, a lower surface of the body 182. The extension wall portion 188 may be stepped. Therefore, a contact area between the extension wall portion 188 and the stopper member 190 may be increased to decrease separation of the stopper member 190.

Here, the bearing clearance will be described. The bearing clearance may be formed by the stator 110 and the rotor 120. That is, the bearing clearance means a clearance formed by the outer peripheral surface of the shaft 170 and the inner peripheral surface of the sleeve 140, a clearance formed by a lower surface of the shaft 170 and an upper surface of the cover member 160, a clearance formed by a lower surface of the sleeve 140 and the upper surface of the cover member 160, and a clearance formed by an upper surface of the sleeve 140 and the lower surface of the rotor hub 180, and all of these bearing clearances may be filled with the lubricating fluid.

Meanwhile, an interface (that is, a liquid-vapor interface) between the lubricating fluid and air maybe disposed in a sealing part 106 formed by an inner peripheral surface of the stopper member 190 and the outer peripheral surface of the sleeve 140.

The stopper member 190 may be fixedly installed on an inner peripheral surface of the extension wall portion 188 and serve to prevent the rotor 120 from being separated from the stator 110 due to external impact. In addition, the stopper member 190 may serve to form the sealing part 106 in which the liquid-vapor interface is formed, as described above. To this end, at least one of the inner peripheral surface of the stopper member 190 and the upper end portion of the outer peripheral surface of the sleeve 140 disposed to face the inner peripheral surface of the stopper member 190 may be inclined.

Meanwhile, the spindle motor 100 according to an exemplary embodiment of the present disclosure may include an impact alleviating part 200 decreasing an impact amount due to the external impact.

The impact alleviating part 200 may be formed in at least one of the stopper member 190 and a facing surface of the sleeve 140 disposed to face the stopper member 190.

As an example, the impact alleviating part 200 may be configured of an impact alleviating groove formed in an upper surface of the stopper member 190. That is, the impact alleviating part 200 may be formed in the upper surface of the stopper member 190 in order to form dynamic pressure in the axial direction at the time of the external impact.

Therefore, in the case in which external force is applied in the axial direction, the impact amount may be decreased by the dynamic pressure generated in the axial direction by the lubricating fluid moving by the external force.

As described above, the impact alleviating part 200 may be formed in the bearing clearance to decrease the impact amount, thereby improving impact characteristics.

As described above, the impact alleviating part 200 configured of the impact alleviating groove may decrease the impact amount in the case in which the external force is applied in the axial direction, whereby the impact characteristics may be improved.

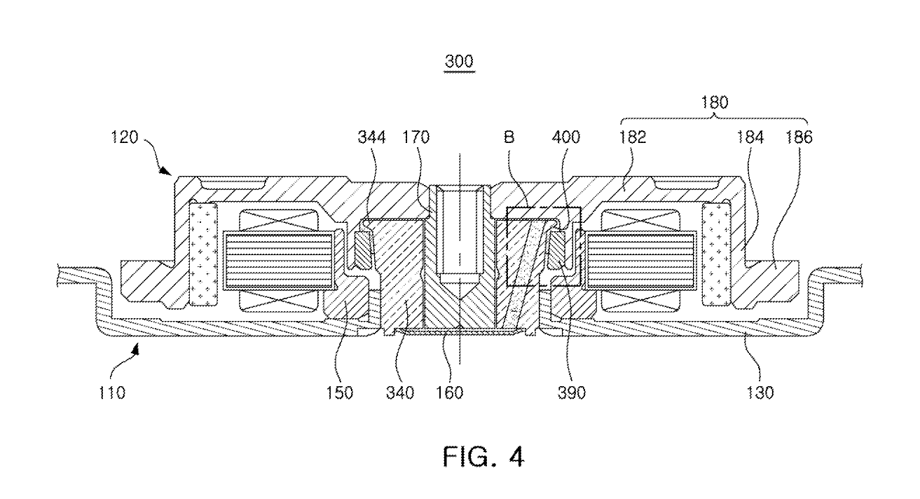

Next, a spindle motor according to another exemplary embodiment of the present disclosure will be described with reference to FIGS. 4 through 6. However, the same components as the above-mentioned components will be denoted by the same reference numerals and a detailed description therefor will be omitted and be replaced by the above-mentioned description.

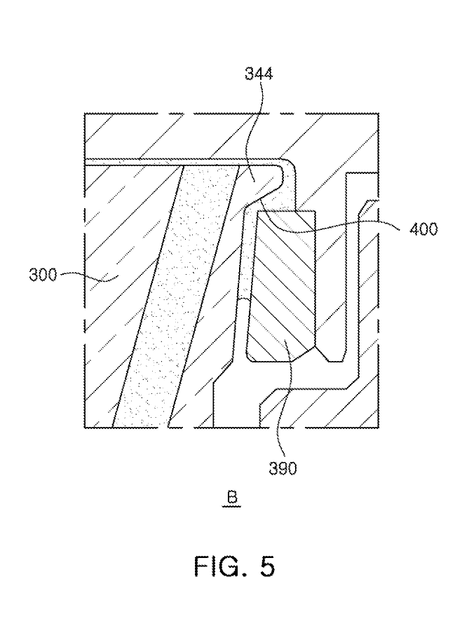

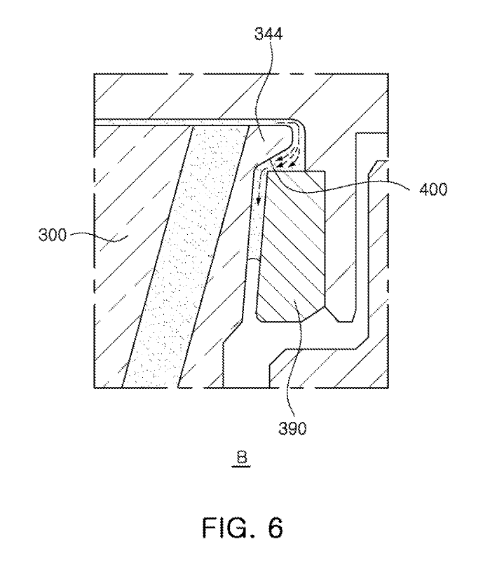

FIG. 4 is a schematic cross-sectional view showing a spindle motor according to another exemplary embodiment of the present disclosure; FIG. 5 is an enlarged view showing part B of FIG. 4; and FIG. 6 is a view for describing an operation of the spindle motor according to another exemplary embodiment of the present disclosure.

Referring to FIGS. 4 through 6, a spindle motor 300 according to another exemplary embodiment of the present disclosure may include a stator 310 and a rotor 320 by way of example.

Meanwhile, since components of the spindle motor 300 according to another exemplary embodiment of the present disclosure except for an impact alleviating part 400 are the same as those of the spindle motor 100 according to an exemplary embodiment of the present disclosure described above, a detailed description therefor will be omitted. That is, since abase member 130, an installation member 150, and a cover member 160 of the stator 310 and a shaft 170 and a rotor hub 180 of the rotor 320 are the same as those of the spindle motor 100 according to an exemplary embodiment of the present disclosure described above, a detailed description therefor will be omitted and be replaced by the above-mentioned description.

Next, only the impact alleviating part 400 will be described in detail.

The impact alleviating part 400 may be formed of an inclined surface so that a width of a clearance formed between the impact alleviating part 400 and an outer surface of a stopper member 390 is changed. That is, a lower surface of a catching jaw 344 of a sleeve 340 may be inclined so that a width of a clearance formed between the lower surface of the catching jaw 344 and an upper surface of the stopper member 390 is changed.

Meanwhile, the inclined surface may be inclined to have a shape in which a clearance formed by the inclined surface and the upper surface of the stopper member 390 becomes narrow in an inner diameter direction in order to generate force in the axial direction.

As described above, since the clearance formed by the lower surface of the catching jaw 344 of the sleeve 340 and the upper surface of the stopper member 390 becomes narrow in the inner diameter direction, in the case in which external impact is applied to the spindle motor, the external impact may be alleviated.

This will be described in more detail. As shown in FIG. 6, in the case in which the external impact is applied to the spindle motor, the lubricating fluid may move from the bearing clearance to the sealing part 106.

Here, the lubricating fluid moving to the sealing part 106 may have pressure rising at a region in which it passes through the impact alleviating part 400, thereby alleviating an impact amount.

In other words, the impact alleviating part 400 may serve as a resistor to a flow of the lubricating fluid, such that the pressure of the lubricating fluid passing through the tapered clearance rises, thereby decreasing the impact amount due to external force.

As described above, impact characteristics may be improved through the impact alleviating part 400 serving as the resistor to the flow of the lubricating fluid due to the external impact.

Meanwhile, although the case in which the spindle motor has a rotating-shaft structure in which the shaft 170 rotates has been described by way of example in the above-mentioned exemplary embodiments, the present disclosure is not limited thereto, but may also be applied to a spindle motor having a fixed-shaft structure in which the shaft is fixed to the stator.

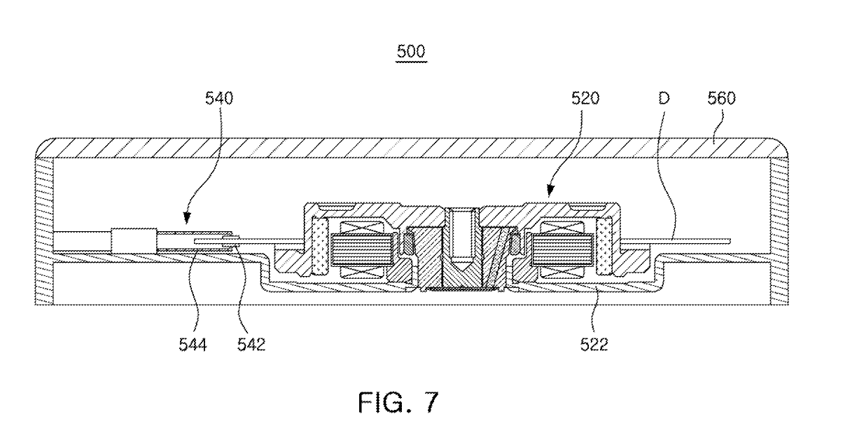

FIG. 7 is a schematic cross-sectional view showing a hard disk drive according to an exemplary embodiment of the present disclosure.

Referring to FIG. 7, a hard disk drive 500 according to an exemplary embodiment of the present disclosure may include a spindle motor 520, a head transfer part 540, and an upper case 560 by way of example.

The spindle motor 520 may be any one of the spindle motors according to an exemplary embodiment and another exemplary embodiment of the present disclosure described above, and may have a recording disk D mounted thereon.

The head transfer part 540 may transfer a head 542 reading information from the recording disk D mounted on the spindle motor 520 to a surface of the recording disk D of which the information is to be detected. The head 542 maybe disposed on a support part 544 of the head transfer part 540.

The upper case 560 may be coupled to a base member 522 in order to form an internal space accommodating the spindle motor 520 and the head transfer part 540 therein.

As set forth above, according to exemplary embodiments of the present disclosure, the impact characteristics may be improved.

While exemplary embodiments have been shown and described above, it will be apparent to those skilled in the art that modifications and variations could be made without departing from the scope of the present invention as defined by the appended claims.

What is claimed is:

1. A spindle motor comprising:
a stator including a sleeve; and
a rotor forming a bearing clearance with the sleeve, the bearing clearance being filled with a lubricating fluid;
wherein the rotor includes a stopper member forming a sealing part with the sleeve, in which a liquid-vapor interface is formed, and
at least one of the stopper member and a surface of the sleeve disposed to face the stopper member is provided with an impact alleviating part formed therein to alleviate external impacts.

2. The spindle motor of claim 1, wherein the impact alleviating part is configured of an impact alleviating groove formed in an upper surface of the stopper member.

3. The spindle motor of claim 1, wherein the impact alleviating part has an inclined surface so that a width of a clearance formed between the impact alleviating part and an outer surface of the stopper member is changed.

4. The spindle motor of claim 3, wherein the inclined surface is inclined to have a shape in which a clearance formed by the inclined surface and an upper surface of the stopper member is narrowed in an inner diameter direction to generate force in an axial direction.

5. The spindle motor of claim 1, wherein the stator includes a base member to which a lower end portion of the sleeve is fixed, an installation member installed on an upper surface of the base member to be disposed in the vicinity of the sleeve, and a cover member installed on the lower end portion of the sleeve to prevent leakage of the lubricating fluid.

6. The spindle motor of claim 1, further comprising a shaft rotatably installed in the sleeve and a rotor hub coupled to an upper end portion of the shaft to thereby rotate with the shaft.

7. The spindle motor of claim 6, wherein the rotor hub has an extension wall portion formed to allow the stopper member to be disposed on the extension wall portion, the extension wall portion being stepped.

8. A spindle motor comprising:
a base member including a mounting part;
a sleeve having a lower end portion fixed to an inner peripheral surface of the mounting part;
a shaft rotatably installed in the sleeve;
a rotor hub fixed to an upper end portion of the shaft and including an extension wall portion extended from a lower surface of the rotor hub;
a stopper member fixedly installed on an inner peripheral surface of the extension wall portion and forming a sealing part in which a liquid-vapor interface is formed, with an outer peripheral surface of the sleeve; and
a cover member fixed to a lower end portion of the sleeve,
wherein at least one of the stopper member and a surface of the sleeve disposed to face the stopper member is provided with an impact alleviating part formed therein to alleviate external impacts.

9. The spindle motor of claim 8, wherein the impact alleviating part has an impact alleviating groove formed in an upper surface of the stopper member.

10. The spindle motor of claim 8, wherein the impact alleviating part has an inclined surface inclined so that a width of a clearance formed by the surface of the sleeve disposed to face an upper surface of the stopper member and the upper surface of the stopper member is narrowed in an inner diameter direction.

11. A hard disk drive comprising:
the spindle motor of claim 1, rotating a recording disk;
a head transfer part transferring a head reading information from the recording disk mounted on the spindle motor to the recording disk; and
an upper case coupled to a base member provided in the spindle motor to form an internal space accommodating the spindle motor and the head transfer part.
